(19) United States
(12) Patent Application Publication
(10) Pub. No.: US 2025/0139830 A1
(43) Pub. Date: May 1, 2025

(54) SURVEILLANCE SYSTEM, SURVEILLANCE APPARATUS, SURVEILLANCE METHOD, AND NON-TRANSITORY COMPUTER-READABLE STORAGE MEDIUM

(71) Applicant: NEC Corporation, Minato-ku, Tokyo (JP)

(72) Inventors: Katsuhiko Takahashi, Tokyo (JP); Takami Sato, Tokyo (JP)

(73) Assignee: NEC Corporation, Minato-ku, Tokyo (JP)

(21) Appl. No.: 18/837,234

(22) PCT Filed: Feb. 22, 2022
(86) PCT No.: PCT/JP2022/007286

§ 371 Date: Aug. 9, 2024

(51) Int. Cl. G06T 7/80; G06V 20/52

(52) U.S. Cl. CPC G06T 7/80; G06V 20/52; G06T 2207/30244

(57) ABSTRACT

A surveillance apparatus (100) includes: a position information acquisition unit (102) that acquires suitable position information allowing determination of a suitable installation position of an image capture apparatus that surveilles a surveillance target position; an image acquisition unit (104) that acquires an image in which an area where the image capture apparatus may be installed is captured; a determination unit (106) that determines the suitable installation position in the image by using the suitable position information; and a display processing unit (108) that causes a display unit to display the determined suitable installation position by superimposition on the image.

### TECHNICAL FIELD

The present invention relates to a surveillance system, a surveillance apparatus, a surveillance method, and a recording medium.

### BACKGROUND ART

In recent years, demand for a surveillance camera has expanded in stores and the like, and applications of such a camera range widely over purposes of not only surveillance and prevention of crimes such as shoplifting and robbery, but also management and sale of products, and consumption behavior analysis of customers.

Even when a plurality of surveillance cameras are installed in a store, complete coverage inside the store is not provided, and a blind area exists. Patent Document 1 describes an example of a surveillance apparatus with a mechanism for covering such a blind area. The surveillance apparatus described in Patent Document 1 uses a second image capture apparatus being a wearable camera worn by a clerk in order to cover a blind area of a stationary surveillance camera being a first image capture apparatus. Then, by notifying an employee of existence of the blind area by displaying the blind area by superimposition on a real video on a display of the wearable camera, the employee can recognize and remove the cause of occurrence of the blind area.

Further, Patent Document 2 describes that in a surveillance camera system, a camera group including a plurality of cameras placed in a store and a POS register for performing checkout of a product constitute a system, and static image data for prompting movement of a camera to a new surveillance position are displayed on a camera-side display unit, based on the surveillance positions of the cameras allocated at the POS register. Thus, the surveillance camera system described in Patent Document 2 does not require determination and operation of an administrator of the surveillance camera system at placement of cameras and flexibly accommodates a change in status of an image capture target.

On the other hand, image recognition using an artificial intelligence (AI) technology such as deep learning has been actively performed in recent years. Patent Document 3 describes an example of a system using such a technology. The system in Patent Document 3 analyzes a camera image, tracks a person in an autonomous store, and decides when the tracked person takes a product in the store in a hand and moves the product. The system described in Patent Document 3 makes a decision on a product taken into a hand from a shelf, placed on the shelf, or moved to the shelf, by a neural network processing images of the shelf before and after the action. Human tracking is performed by analyzing an image from a ceiling-mounted fisheye camera, the image being projected on a plane horizontal to the floor. The projected ceiling-mounted camera image is analyzed by using a neural network trained to recognize the position of a shopper. Further, as needed, a camera is moved, and/or the number of cameras is increased for optimization of the number of cameras in the system.

### RELATED DOCUMENTS

### Patent Documents

Patent Document 1: Japanese Patent Application Publication No. 2016-82506
Patent Document 2: Japanese Patent Application Publication No. 2005-286619
Patent Document 3: Japanese Patent Application Publication No. 2020-53019

### SUMMARY OF INVENTION

### Technical Problem

The aforementioned technology described in Patent Document 2 changes allocation of the cameras according to a status change in a salesfloor and displays static image data (such as a message or a mark indicating a salesfloor being the destination) prompting movement of a camera on the display unit on the camera side. A clerk viewing the display moves the camera. Thus, the technology described in Patent Document 2 only notifies a clerk of a salesfloor or the like being the destination of a camera.

In image recognition using an AI technology, a specialized engineer generally goes to a site at introduction of a camera and determines the installation position of the camera suited for AI. The reason is that precision of image recognition using an AI technology depends on the installation position of a camera and therefore it is difficult for a clerk being a non-engineer without expertise to determine a suitable installation position allowing improved precision of image recognition. Further, the aforementioned technology described in Patent Document 3 includes description about movement of a camera but does not assume a suitable installation position guaranteeing image recognition precision to be determined by a clerk without expertise.

Therefore, the aforementioned technologies described in Patent Documents may be able to determine a destination salesfloor of a camera, but none can install the camera at a suitable installation position allowing improved precision of image recognition using an AI technology, and therefore there is an issue that movement and installation of a camera by a clerk without expertise degrades precision of image recognition.

An example of an object of the present invention is to, in view of the issue described above, provide a surveillance system, a surveillance apparatus, a surveillance method, and a recording medium that resolve degradation in image recognition precision caused by the installation position of a camera in store surveillance.

### Solution to Problem

An aspect of the present invention provides a surveillance apparatus including:
a position information acquisition unit that acquires suitable position information allowing determination of a suitable installation position of an image capture unit that surveilles a surveillance target position;
an image acquisition unit that acquires an image in which an area where the image capture unit may be installed is captured;
a determination unit that determines the suitable installation position in the image by using the suitable position information; and
a display processing unit that causes a display unit to display the determined suitable installation position by superimposition on the image.

An aspect of the present invention provides a surveillance system including:
a second image capture unit that captures, from a surveillance target position, an image of an area where a first image capture unit that surveilles the surveillance target position may be installed;
a storage unit that stores suitable position information allowing determination of a suitable installation position of the first image capture unit;
a display unit;
a position information acquisition unit that acquires the suitable position information from the storage unit;
an image acquisition unit that acquires an image of an area where the first image capture unit an image of which is captured by the second image capture unit may be installed;
a determination unit that determines the suitable installation position in the image by using the suitable position information; and
a display processing unit that causes the display unit to display the determined suitable installation position by superimposition on the image.

An aspect of the present invention provides a surveillance method including, by one or more computers:
acquiring suitable position information allowing determination of a suitable installation position of an image capture unit that surveilles a surveillance target position;
acquiring an image in which an area where the image capture unit may be installed is captured;
determining the suitable installation position in the image by using the suitable position information; and
causing a display unit to display the determined suitable installation position by superimposition on the image.

An aspect of the present invention provides a computer-readable recording medium on which a program is recorded, the program causing a computer to execute:
a procedure for acquiring suitable position information allowing determination of a suitable installation position of an image capture unit that surveilles a surveillance target position;
a procedure for acquiring an image in which an area where the image capture unit may be installed is captured;
a procedure for determining the suitable installation position in the image by using the suitable position information; and
a procedure for causing a display unit to display the determined suitable installation position by superimposition on the image.

Note that another aspect of the present invention may be a program causing one or more computers to execute the method according to the aforementioned aspect or a computer-readable recording medium on which such a program is recorded. The recording medium includes a non-transitory tangible medium.

The computer program includes a computer program code causing a computer to execute the surveillance method on a surveillance apparatus when being executed by the computer.

Note that any combination of the components described above, and representations of the present invention converted between a method, an apparatus, a system, a recording medium, a computer program, and the like are also valid as aspects of the present invention.

Further, various components of the present invention do not necessarily need to be individually independent, and for example, a plurality of components may be formed as a single member, a plurality of members may form a single component, a certain component may be part of another component, and part of a certain component may overlap with part of another component.

Further, while a plurality of procedures are described in a sequential order in the method and the computer program according to the present invention, the order of description does not limit the order of execution of the plurality of procedures. Therefore, when the method and the computer program according to the present invention are executed, the order of the plurality of procedures may be changed without affecting the contents.

Furthermore, a plurality of procedures in the method and the computer program according to the present invention are not limited to be executed at timings different from each other. Therefore, for example, a certain procedure may be generated during execution of another procedure, and an execution timing of a certain procedure and an execution timing of another procedure may overlap with each other in part or in whole.

### Advantageous Effects of Invention

One aspect of the present invention can provide a surveillance system, a surveillance apparatus, a surveillance method, and a recording medium that resolve degradation in image recognition precision caused by the installation position of a camera in store surveillance.

### BRIEF DESCRIPTION OF THE DRAWINGS

FIG. 1 It is a diagram illustrating an overview of a surveillance apparatus according to an example embodiment.

FIG. 2 It is a flowchart illustrating an operation example of the surveillance apparatus according to the present example embodiment.

FIG. 3 It 3 is a diagram conceptually illustrating a system configuration of a surveillance system according to an example embodiment in operation.

FIG. 4 It is a diagram conceptually illustrating a system configuration of the surveillance system according to the example embodiment in a preparation stage.

FIG. 5 It is a block diagram illustrating a hardware configuration of a computer providing the surveillance apparatus in FIG. 1.

FIG. 6 It is a diagram for illustrating a relation between a camera position at constructing learning data and a camera position at event detection.

FIG. 7 It is a diagram illustrating a scene in which a positioning camera is tentatively placed on a display shelf.

FIG. 8 It is a diagram illustrating an example of a screen on which a suitable installation area is displayed by superimposition.

FIG. 9 It is a functional block diagram illustrating a logical configuration example of a surveillance apparatus according to an example embodiment.

FIG. 10 It is a diagram for illustrating suitable position information.

FIG. 11 It is a diagram illustrating a display example of suitable position information for each event.

FIG. 12 It is a flowchart illustrating an operation example of the surveillance apparatus according to the example embodiment.

FIG. 13 It is a functional block diagram illustrating a configuration example of a main part of a surveillance apparatus according to an example embodiment.

FIG. 14 It is a flowchart illustrating an operation example of the surveillance apparatus according to the example embodiment.

FIG. 15 It is a functional block diagram illustrating a logical configuration example of a surveillance apparatus according to an example embodiment.

FIG. 16 It is a flowchart illustrating an operation example of the surveillance apparatus according to the example embodiment.

FIG. 17 It is a diagram illustrating a configuration example of a surveillance apparatus according to an example embodiment.

### EXAMPLE EMBODIMENT

Example embodiments of the present invention will be described below by using drawings. Note that in every drawing, similar components are given similar signs, and description thereof is not included as appropriate. Further, in each of the following diagrams, a configuration of a part not related to the essence of the present invention is not included and is not illustrated.

In the example embodiments, “acquisition” includes at least one item out of an apparatus getting data or information stored in another apparatus or storage medium (active acquisition), and an apparatus inputting data or information output from another apparatus to the apparatus (passive acquisition). Examples of the active acquisition include making a request or an inquiry to another apparatus and receiving a response, and readout by accessing another apparatus or storage medium. Further, examples of the passive acquisition include reception of distributed (or, for example, transmitted or push notified) information. Furthermore, “acquisition” may refer to selective acquisition from received data or information, or selective reception of distributed data or information.

### <Minimum Configuration Example>

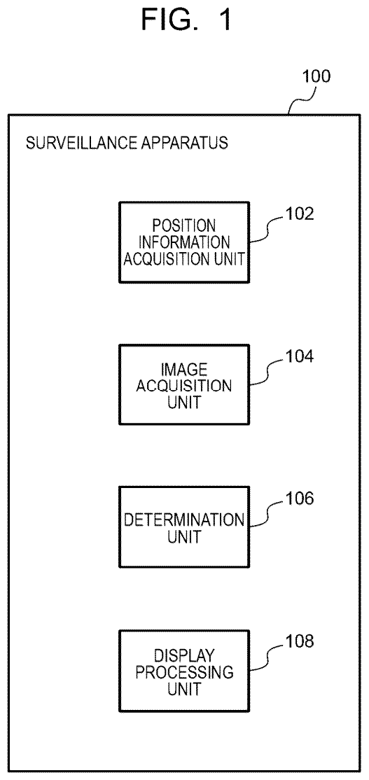

FIG. 1 is a diagram illustrating an overview of a surveillance apparatus 100 according to an example embodiment. The surveillance apparatus 100 includes a position information acquisition unit 102, an image acquisition unit 104, a determination unit 106, and a display processing unit 108.

The position information acquisition unit 102 acquires suitable position information allowing determination of a suitable installation position of a camera (an image capture unit) that surveilles a surveillance target position.

The image acquisition unit 104 acquires an image in which an area where a camera may be installed is captured.

The determination unit 106 determines a suitable installation position in the image by using the suitable position information.

The display processing unit 108 causes a display unit to display the determined suitable installation position by superimposition on the image.

The camera surveilling a surveillance target position is also referred to as an event detection camera. Further, a camera capturing an image acquired by the image acquisition unit 104 is also referred to as a positioning camera. The event detection camera may be used as the positioning camera, or another camera may be used.

### <Operation Example>

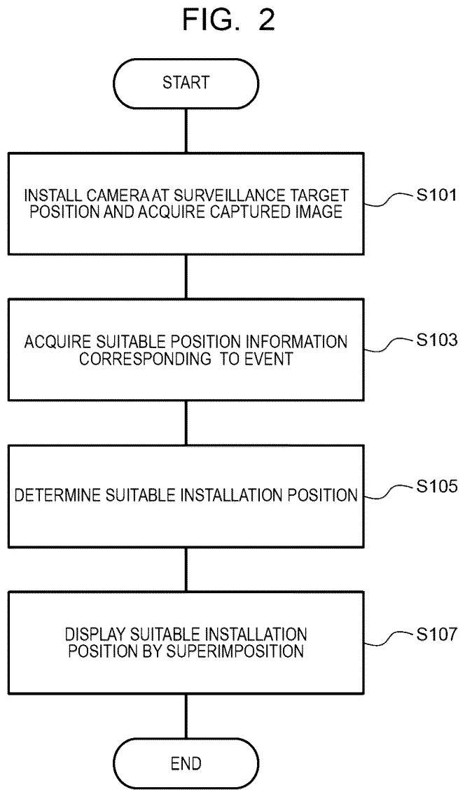

FIG. 2 is a flowchart illustrating an operation example of the surveillance apparatus 100 according to the present example embodiment.

First, the positioning camera is tentatively placed at a surveillance target position in such a way as to capture an image of an area where the event detection camera may be installed. The position information acquisition unit 102 acquires suitable position information allowing determination of a suitable installation position of the event detection camera surveilling the surveillance target position (Step S101). By using the positioning camera, the image acquisition unit 104 acquires an image in which the area where the event detection camera may be installed is captured (Step S103).

By using the suitable position information, the determination unit 106 determines a suitable installation position in the image (Step S105). The display processing unit 108 causes the display unit to display the determined suitable installation position by superimposition on the image (Step S107).

The surveillance apparatus 100 includes the position information acquisition unit 102, the image acquisition unit 104, the determination unit 106, and the display processing unit 108. In the surveillance apparatus 100, the position information acquisition unit 102 acquires suitable position information allowing determination of a suitable installation position of the event detection camera, and by using the positioning camera, the image acquisition unit 104 acquires an image in which an area where the event detection camera may be installed is captured. Then, the determination unit 106 determines a suitable installation position in the image by using the suitable position information, and the display processing unit 108 causes the display unit to display the determined suitable installation position by superimposition on the image.

In general, an engineer goes to a site at installation of a camera detecting an event by image processing, judges an optimum position for image recognition, and determines an installation position. A suitable installation position is displayed on the display unit by the display processing unit 108 in the surveillance apparatus 100, and therefore an installer without expertise, such as a clerk, can capture an image suited for detection of an event being a detection target by installing the event detection camera at the suitable installation position in accordance with the display. Detection of the event can be performed by performing image processing on an image captured by the event detection camera installed at the suitable installation position.

Thus, the surveillance apparatus 100 can resolve degradation in image recognition precision caused by the installation position of a camera in store surveillance.

Detailed examples of the surveillance apparatus 100 will be described below.

### First Example Embodiment

### <System Overview>

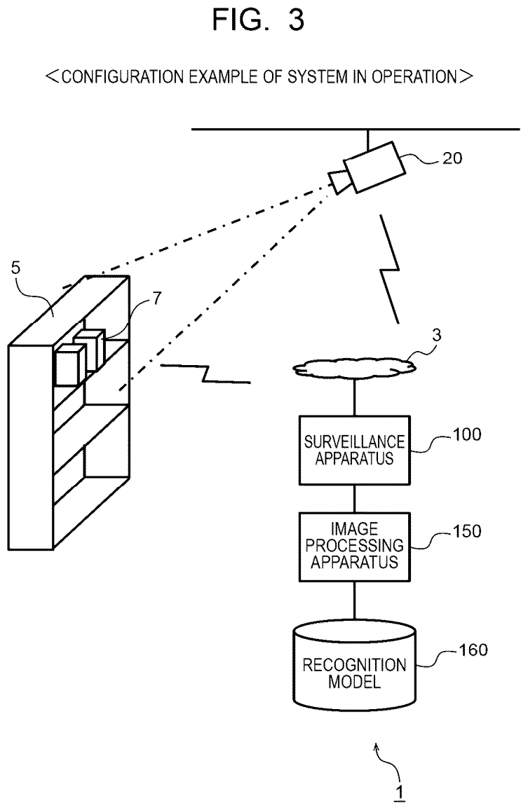

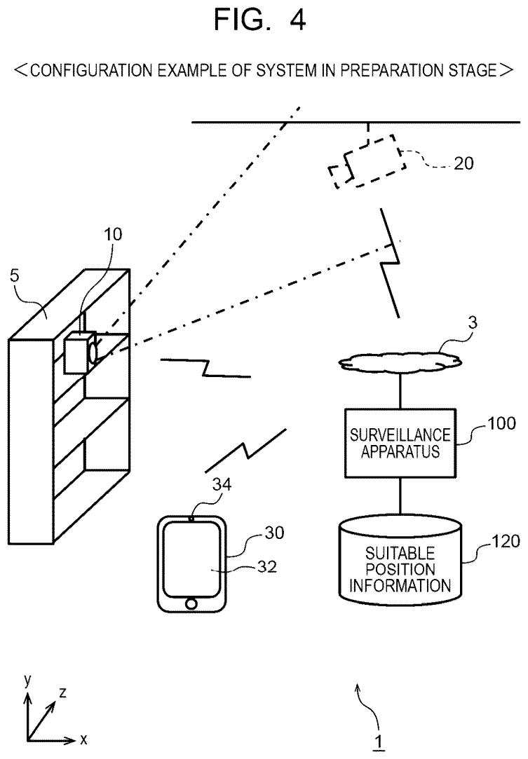

FIG. 3 and FIG. 4 are diagrams conceptually illustrating a system configuration of a surveillance system 1 according to an example embodiment. FIG. 3 illustrates a system configuration example of the surveillance system 1 in operation. FIG. 4 illustrates a system configuration example of the surveillance system 1 in a preparation stage for determining an installation position of an event detection camera 20.

The surveillance system 1 includes a surveillance apparatus 100 that detects a predetermined event by using an image captured by the event detection camera 20. The surveillance apparatus 100 detects the predetermined event at a surveillance target location by performing image processing on the image captured by the event detection camera 20 by using an image processing apparatus 150. The image processing apparatus 150 detects the predetermined event by performing image recognition processing on the image captured by the event detection camera 20 by using a recognition model 160.

For example, the event detection camera 20 is a wireless camera with a wireless communication function, and the installation location of the camera may be freely moved. The configuration can provide the surveillance apparatus 100 not degrading image recognition precision of event detection in the movable event detection camera 20.

The image processing apparatus 150 according to the example embodiment performs image recognition processing by using the recognition model 160 generated by using machine learning or deep learning being one of so-called AI technologies. The recognition model 160 is created from learning data and may be provided for each surveillance target location or each predetermined event. “Learning” hereinafter refers to, but not limited to, at least one item out of machine learning, a neural network, and deep learning.

When a surveillance target location is a store, examples of the predetermined event include a customer stopping in front of a display shelf 5, a customer taking a product 7 in a hand, a customer returning a product 7 after taking the product 7 in a hand, a customer taking a product 7 away (such as putting the product 7 into a shopping basket) for purchase, a clerk performing shelf stocking work of a product 7, stockout status of a product 7 on a display shelf 5, a display state, a product 7 not facing the front or the product 7 being brought down, a product 7 being moved from a predetermined location, shoplifting, and tampering with a product 7.

Further, for example, in a case of an event of putting in and taking out a product 7, a product 7 at a specific position (such as information indicating the height of a detection target in the display shelf 5) on a display shelf 5 at a specific position (such as a so-called end shelf) being taken out may be considered an event.

The event is not limited to the above. Other examples of the predetermined event being a detection target include a person staying put, baggage theft, harassment such as molestation, a crime, kidnapping, a quarrel, violence, a lost article, a suspicious article, and an emergency patient that are found in a station premise or a moving vehicle.

As illustrated in FIG. 4, the surveillance system 1 includes the surveillance apparatus 100 and a positioning camera 10 connected to the surveillance apparatus 100 through a communication network 3 in the system configuration example in the preparation stage. The surveillance apparatus 100 includes a suitable position information storage apparatus 120 that indicates a suitable installation position of the event detection camera 20. The suitable position information storage apparatus 120 may be provided inside the surveillance apparatus 100 or outside the surveillance apparatus 100. In other words, the suitable position information storage apparatus 120 may be hardware integrated with the surveillance apparatus 100 or hardware separate from the surveillance apparatus 100. While the image processing apparatus 150 and the recognition model 160 are not illustrated in FIG. 4, the image processing apparatus 150 and the recognition model 160 may be included in the surveillance system 1 in the preparation stage in FIG. 4 as well.

The positioning camera 10 is tentatively placed at a surveillance target position in such a way as to capture an image of an area where the event detection camera may be installed. While the installation position of the event detection camera 20 can be freely changed, an image generated by the event detection camera 20 is used for image recognition processing using the recognition model 160, and therefore the camera needs to be installed at a suitable location for improved precision of the recognition result. Therefore, according to the example embodiment, the event detection camera 20 is installed at a suitable installation position determined by the surveillance system 1 in FIG. 4, and the surveillance system 1 in FIG. 3 detects a predetermined event. Thus, an image allowing improved recognition precision can be captured.

Each of the positioning camera 10 and the event detection camera 20 includes a lens and an image pickup device such as a charge coupled device (CCD) image sensor and is, for example, a network camera such as an Internet Protocol (IP) camera. For example, the network camera has a wireless local area network (LAN) communication function and is connected to the surveillance apparatus 100 through the communication network 3, that is, relaying apparatuses (unillustrated) such as routers. The cameras may be a plurality of so-called surveillance cameras installed in a store or a facility. Then, the camera may include a mechanism for following movement of a person and performing control of the directions of the camera body and/or the lens, zoom control, focusing, and the like.

It is preferable that images generated by a camera be captured in real time and be transmitted to the surveillance apparatus 100 through the communication network 3. The images transmitted to the surveillance apparatus 100 may not be directly transmitted from the camera and may be images delayed by a predetermined time. Images captured by the camera may be temporarily stored in another storage apparatus and be read from the storage apparatus by the surveillance apparatus 100 sequentially or at predetermined intervals. Furthermore, while images transmitted to the surveillance apparatus 100 are preferably dynamic images, the images may be frame images generated at predetermined intervals or static images.

Furthermore, the surveillance system 1 may include an operation terminal 30 in the preparation stage. The operation terminal 30 includes a display 32 and a camera 34. For example, the operation terminal 30 is a terminal operated by each operator such as a clerk and is a computer such as a personal computer, a smartphone, or a tablet terminal.

For example, the display 32 is a liquid crystal display or an organic electro-luminescence (EL) display. Further, the display 32 may be a touch panel integrated with an operation unit.

### <Hardware Configuration Example>

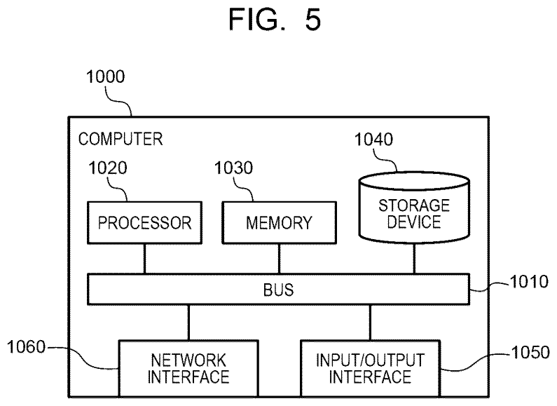

FIG. 5 is a block diagram illustrating a hardware configuration of a computer 1000 providing the surveillance apparatus 100 in FIG. 1. The image processing apparatus 150 in FIG. 3 (and FIG. 4) and the operation terminal 30 in FIG. 4 are also provided by the computer 1000. Further, the event detection camera 20 in FIG. 3, the positioning camera 10 in FIG. 4, and a learning camera 22 to be described later are also provided by the computer 1000. Further, the operation terminal 30 may provide at least part of the functions of the surveillance apparatus 100.

The computer 1000 includes a bus 1010, a processor 1020, a memory 1030, a storage device 1040, an input/output interface 1050, and a network interface 1060.

The bus 1010 is a data transmission channel for the processor 1020, the memory 1030, the storage device 1040, the input/output interface 1050, and the network interface 1060 to transmit and receive data to and from each other. Note that the method for interconnecting the processor 1020 and other components is not limited to a bus connection.

The processor 1020 is a processor provided by a central processing unit (CPU), a graphics processing unit (GPU), or the like.

The memory 1030 is a main storage provided by a random-access memory (RAM) or the like.

The storage device 1040 is an auxiliary storage provided by a hard disk drive (HDD), a solid-state drive (SSD), a memory card, a read-only memory (ROM), or the like. Program modules for providing the functions of the surveillance apparatus 100 (such as a position information acquisition unit 102, an image acquisition unit 104, a determination unit 106, a display processing unit 108, and an output processing unit 112 and a notification unit 116 to be described later) are stored in the storage device 1040. By reading each program module into the memory 1030 and executing the program module by the processor 1020, each function related to the program module is provided. Further, data in each of the suitable position information storage apparatus 120 in the surveillance apparatus 100 and the recognition model 160 in the image processing apparatus 150 may also be stored in the storage device 1040.

Each program module may be recorded on a recording medium. The recording medium on which the program module is recorded includes a non-transitory tangible medium usable to the computer 1000, and a program code readable by the computer 1000 (the processor 1020) may be embedded in the medium.

The input/output interface 1050 is an interface for connecting the computer 1000 to various types of input/output equipment. The input/output interface 1050 also functions as a communication interface performing short-distance wireless communication such as Bluetooth (registered trademark) or near-field communication (NFC).

The network interface 1060 is an interface for connecting the computer 1000 to a communication network. Examples of the communication network include a local area network (LAN) and a wide area network (WAN). The method for connecting the network interface 1060 to the communication network may be a wireless connection or a wired connection.

Then, the computer 1000 is connected to required equipment (such as the display 32, the camera 34, an operation button, a speaker, and a microphone in the operation terminal 30) through the input/output interface 1050 or the network interface 1060.

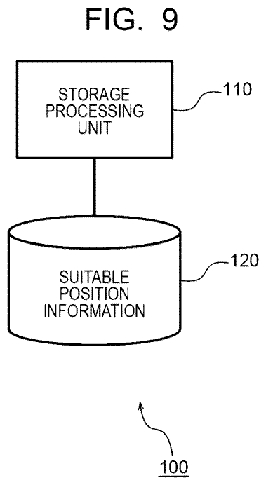

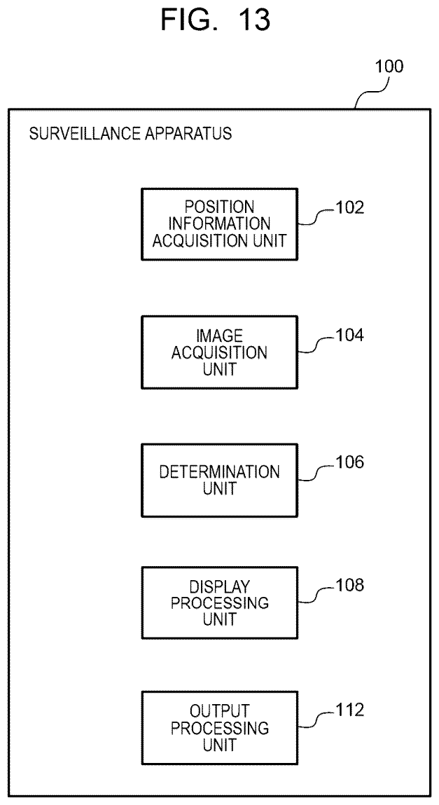

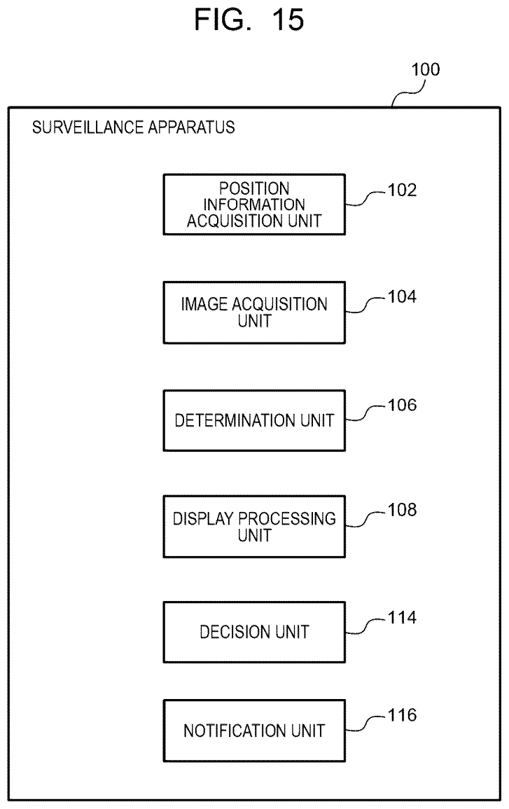

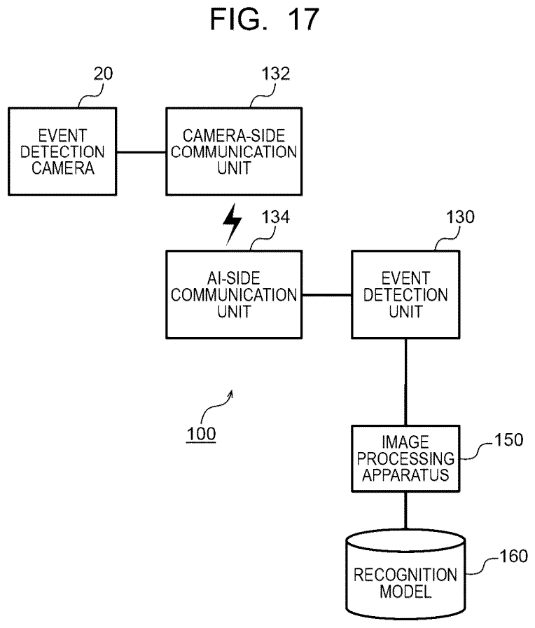

Each component in the surveillance apparatuses 100 according to the example embodiments in FIG. 1, and FIG. 9, FIG. 13, FIG. 15, and FIG. 17 to be described later is provided by any combination of hardware and software of the computer 1000 in FIG. 5. Then, it may be understood by a person skilled in the art that various modifications to the providing method and the apparatus can be made. A functional block diagram illustrating the surveillance apparatus 100 according to each example embodiment represents logical function-based blocks rather than a hardware-based configuration.

### <Functional Configuration Example>

The surveillance apparatus 100 will be described below by using FIG. 1.

The position information acquisition unit 102 acquires suitable position information allowing determination of a suitable installation position of the event detection camera 20 surveilling a surveillance target position. Specifically, the position information acquisition unit 102 acquires suitable position information by readout from the suitable position information storage apparatus 120.

A surveillance target position includes at least part of a display shelf 5 on which a product 7 is displayed. Thus, a predetermined event specific to a store as described above can be detected with high precision.

The suitable position information storage apparatus 120 stores suitable installation position information of the event detection camera 20 for the positions of a display shelf 5 and a product 7 being surveillance targets.

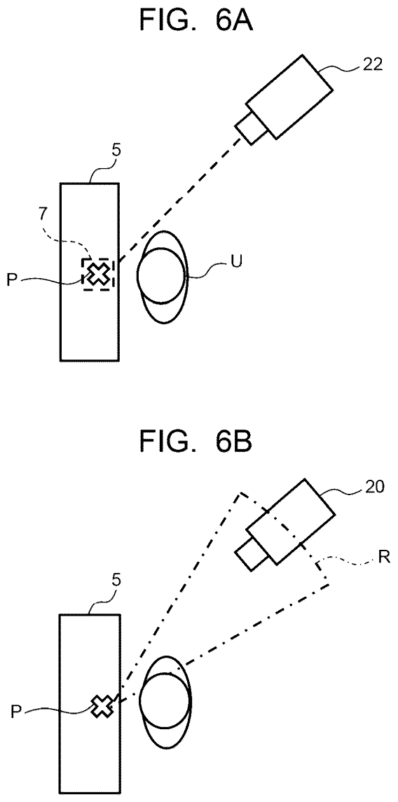

FIG. 6 is a diagram for illustrating a relation between a camera position at constructing learning data and a camera position at event detection. In FIG. 6 (a) illustrates an installation position of the learning camera 22 at constructing learning data for recognizing a predetermined event. In FIG. 6 (b) illustrates an installation position of the event detection camera 20 at event detection. Note that the same camera may be used as the learning camera 22 and the event detection camera 20.

In this example, the learning camera 22 captures an image for collecting learning data with an event of a person U in front of a display shelf 5 taking a product 7 at a position P in a hand as a detection target. By installing the event detection camera 20 at the same position as the position of the learning camera 22, improved recognition precision is expected. Therefore, as illustrated in FIG. 6 (b), it is suitable to install the event detection camera 20 within the limits of a range R on the basis of the position P.

A suitable installation position indicates an image capture direction of the event detection camera 20 based on a surveillance target position. As described above, setting the image capture direction of the event detection camera 20 to the same direction as that at generation of learning data allows improved precision of image recognition using the learning data. Note that details of the suitable installation position will be described in a second example embodiment.

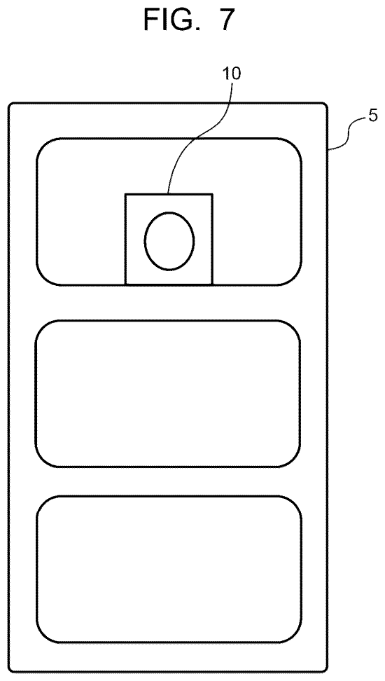

The image acquisition unit 104 acquires an image in which an area where the event detection camera 20 may be installed is captured. The image acquisition unit 104 acquires an image captured by the positioning camera 10. FIG. 7 is a diagram illustrating a scene in which the positioning camera 10 is tentatively placed on a display shelf 5. As illustrated, the positioning camera 10 is tentatively placed at a surveillance target position. In other words, an image acquired by the image acquisition unit 104 is an image captured from the surveillance target position.

Since the image acquisition unit 104 in this configuration acquires an image in which an area where the event detection camera 20 may be installed, a suitable installation position of the event detection camera 20 can be displayed by superimposition on an image in which the area where the event detection camera 20 may be installed. Since a suitable installation position of the event detection camera 20 at a planned installation location can be specifically confirmed, installation work of the event detection camera 20 is facilitated and assisted.

The determination unit 106 determines a suitable installation position in an image by using suitable position information acquired by the position information acquisition unit 102. An “image” herein refers to an image captured by the positioning camera 10. Specifically, the determination unit 106 determines a suitable installation area of the event detection camera 20 by allowing for a predetermined margin in each of a horizontal direction and a vertical direction of an image capture direction of the event detection camera 20 based on the surveillance target position, the image capture direction being indicated by the suitable position information.

Further, the determination unit 106 may perform processing of correcting distortion aberration caused by distortion of the lens of the event detection camera 20 on the suitable position information of the event detection camera 20.

The display processing unit 108 causes a display unit to display a determined suitable installation position by superimposition on an image. The display processing unit 108 causes the display 32 of the operation terminal 30 to display the image in the example in the example embodiment. In another example, the display unit may be a display of the positioning camera 10. Alternatively, the camera 34 on the operation terminal 30 may be used as the positioning camera 10, and the display unit may be the display 32 of the operation terminal 30 in that case as well.

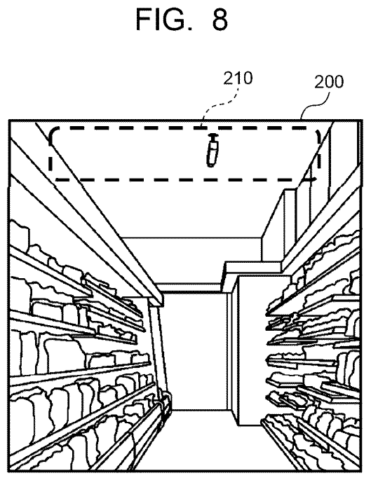

FIG. 8 is a diagram illustrating an example of a screen 200 on which a suitable installation area 210 is displayed by superimposition. The screen 200 includes a video being captured by the positioning camera 10 and a drawing element indicating the suitable installation area 210 determined by the determination unit 106 on the video.

Examples of a drawing element indicating the suitable installation area 210 include a line drawing indicating the suitable installation area 210 by a frame and a drawing of highlighting or a shaded pattern indicating an area covering the suitable installation area 210. The display processing unit 108 causes the display 32 of the operation terminal 30 to display the drawing element by superimposition on the video being captured by the positioning camera 10. The image displayed by the display processing unit 108 is herein described to be a dynamic image but may be a static image.

### <Operation Example>

An operation example of the surveillance apparatus 100 will be described by using FIG. 2.

First, the positioning camera 10 is tentatively placed at a surveillance target position such as a display shelf 5 in such a way as to capture an image of an area where the event detection camera 20 may be installed. Then, the position information acquisition unit 102 acquires suitable position information allowing determination of a suitable installation position of the event detection camera 20 by readout from the suitable position information storage apparatus 120 (Step S101). By using the positioning camera 10, the image acquisition unit 104 acquires an image in which an area where the event detection camera 20 may be installed is captured (Step S103). As described above, the image acquisition unit 104 may acquire a video being captured by the positioning camera 10 in real time.

By using the suitable position information acquired in Step S101, the determination unit 106 determines a suitable installation position (a suitable installation area) in the image captured by the positioning camera 10 (Step S105). The display processing unit 108 causes the display 32 of the operation terminal 30 to display a drawing element indicating the determined suitable installation area 210 by superimposition on the image captured by the positioning camera 10 (Step S107).

The surveillance apparatus 100 includes the position information acquisition unit 102, the image acquisition unit 104, the determination unit 106, and the display processing unit 108. In the surveillance apparatus 100, the position information acquisition unit 102 acquires suitable position information allowing determination of a suitable installation position of the event detection camera, and by using the positioning camera, the image acquisition unit 104 acquires an image in which an area where the event detection camera may be installed is captured. Then, the determination unit 106 determines a suitable installation position in the image by using the suitable position information, and the display processing unit 108 causes the display unit to display the determined suitable installation position by superimposition on the image.

Thus, the surveillance apparatus 100 can resolve degradation in image recognition precision caused by the installation position of a camera in store surveillance.

### Second Example Embodiment

FIG. 9 is a functional block diagram illustrating a logical configuration example of a surveillance apparatus 100 according to an example embodiment. The present example embodiment is the same as the aforementioned example embodiment except for including a configuration in which, in a preparation stage, a suitable installation position of an event detection camera 20 is determined and suitable position information is stored. The surveillance apparatus 100 in FIG. 9 further includes a storage processing unit 110. The storage processing unit 110 may be provided by a computer 1000 separate from the surveillance apparatus 100 in FIG. 1. Note that the configuration according to the present example embodiment may be combined with at least one of configurations according to other example embodiments without contradicting each other.

### <Functional Configuration Example>

At constructing learning data used for detecting an event by performing image processing on an image generated by the event detection camera 20, the storage processing unit 110 previously stores information allowing determination of the position of a learning camera 22 (an image capture unit) that captures an image of a surveillance target position into a suitable position information storage apparatus 120 as suitable position information.

A position information acquisition unit 102 acquires the suitable position information by readout from the suitable position information storage apparatus 120.

Examples of the storage format of suitable position information include the following but are not limited thereto. Further, as for a suitable installation position, an engineer may measure information allowing determination of the learning camera 22 at constructing learning data [such as angle information (angles θ and a) to be described later], and input of the measured value may be accepted as suitable position information. Alternatively, the image processing apparatus 150 may determine angle information (angles θ and a) to be described later by image processing. Note that an angle α is an allowable range of an angle θ and, for example, may be a value predetermined in consideration of the angle of view of the event detection camera 20. Alternatively, the angle α may be a value set according to the type of event.

Suitable position information stored in the suitable position information storage apparatus 120 may be stored in association with learning data of an event being a detection target and being stored in a recognition model 160.

Further, storage processing of suitable position information by the storage processing unit 110 may be appropriately performed according to addition, update, or deletion of an event being a detection target.

### Example 1: Store in Image Format

The storage processing unit 110 stores suitable position information into the suitable position information storage apparatus 120 in an image format indicating an area where the event detection camera 2 may be installed.

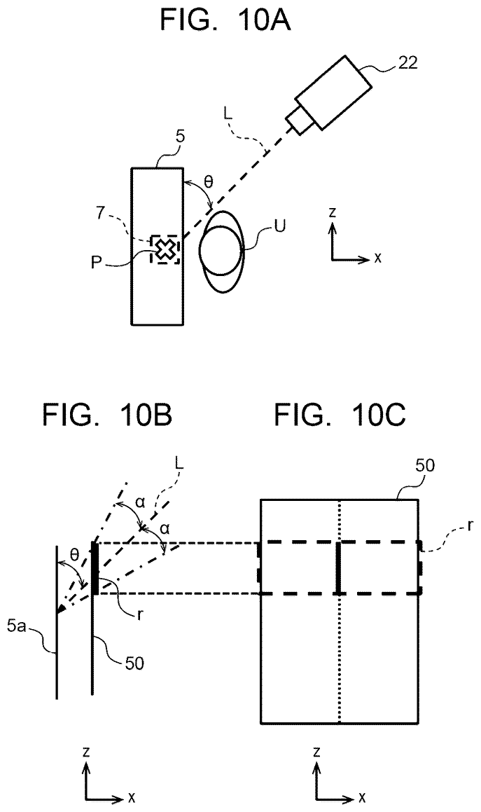

FIG. 10 is a diagram for illustrating suitable position information. Note that x-y-z coordinates in the diagram indicate coordinates illustrated in FIG. 4.

In FIG. 10 (a) illustrates an angle θ being an angle made between an optical axis L of the learning camera 22 capturing an image for generating learning data and a front face 5a of a display shelf 5. An angular range r of a around the angle θ is set to be a suitable installation position in FIG. 10 (b). The range r in the horizontal direction (a rectangular range represented by broken lines) is expressed in a format of an image projected onto an image plane 50 in FIG. 10 (c).

In the example in FIG. 10, the range r of a suitable installation position in the horizontal direction is illustrated. Furthermore, as for the suitable installation position, the range r of the suitable installation position in the vertical direction is similarly set. The storage processing unit 110 stores a range being the logical conjunction of the range in the horizontal direction and the range in the vertical direction into the suitable position information storage apparatus 120 as a suitable installation position. Note that the range r of the suitable installation position in the horizontal direction and the range r of the suitable installation position in the vertical direction may be individually stored into the suitable position information storage apparatus 120. The determination unit 106 may read the range r of the suitable installation position in the horizontal direction and the range r of the suitable installation position in the vertical direction from the suitable position information storage apparatus 120 and set a range being the logical conjunction of the range in the horizontal direction and the range in the vertical direction to be a suitable installation position.

### Example 2: Store as Numerical Data

The storage processing unit 110 stores suitable position information into the suitable position information storage apparatus 120 as numerical data indicating an installation direction of the event detection camera 20 based on a surveillance target position.

In this example, the storage processing unit 110 stores values of the angles θ and a in FIG. 10 (b) for both the horizontal direction and the vertical direction into the suitable position information storage apparatus 120.

The determination unit 106 can convert a suitable installation position into data in an image format indicating the suitable installation area 210 in FIG. 8 by using the values of the angles θ and α read from the suitable position information storage apparatus 120. For example, the determination unit 106 can set a range being the logical conjunction of a range of the suitable installation position in the horizontal direction and a range of the suitable installation position in the vertical direction that are converted by using the values of the angles θ and α to a suitable installation position in this example as well.

As described above, an image generated by the event detection camera 20 is used for detecting an event. The position information acquisition unit 102 acquires suitable position information for each event.

When a plurality of events are set to be detection targets, the determination unit 106 determines a suitable installation position by using suitable position information of the plurality of events.

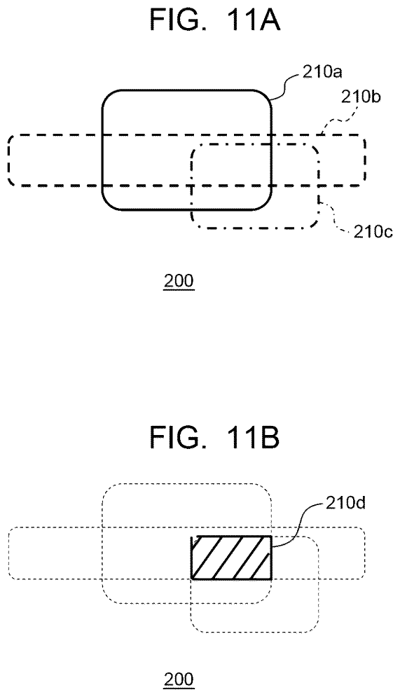

FIG. 11 is a diagram illustrating a display example of suitable position information for each event.

Three suitable installation areas 210a, 210b, and 210c are displayed by superimposition on a screen 200 in an example in FIG. 11 (a). It is preferable that the three suitable installation areas 210a, 210b, and 210c be distinguishably displayed by superimposition by using different drawing elements. For example, the drawing elements are distinguishable from each other by changing the type of line or shaded pattern or changing the color of line or shading.

Information indicating an event corresponding to each suitable installation area 210 may be further displayed on the screen 200 as a legend of the suitable installation area 210.

A drawing element indicating an area 210d being the logical conjunction of the three suitable installation areas 210a, 210b, and 210c is displayed by superimposition on the screen 200 as a suitable installation area in an example in FIG. 11(b).

### <Operation Example>

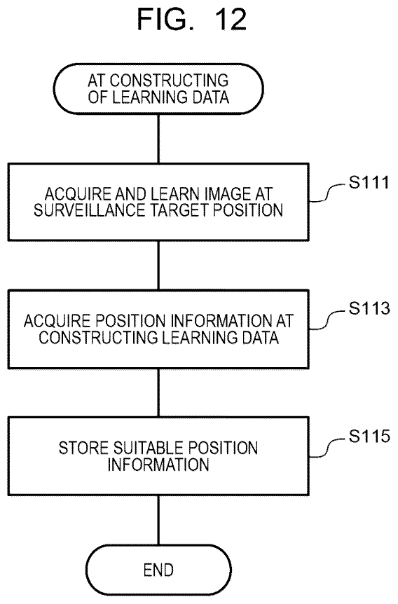

FIG. 12 is a flowchart illustrating an operation example of the surveillance apparatus 100 according to the example embodiment.

The flow illustrates storage processing of suitable position information in a preparation stage. First, before the start of the processing, the learning camera 22 is placed at a position where an image for detecting an event at a surveillance target position is captured. Then, the image processing apparatus 150 in the surveillance apparatus 100 acquires an image from the learning camera 22 and constructs learning data for event detection (Step S11).

Then, the storage processing unit 110 acquires position information of the learning camera 22 (angles θ and α) at constructing the learning data using the captured image (Step S113). As described above, the position information may be acquired by accepting input of a measured value measured by an engineer, or a value computed by the image processing apparatus 150 by image processing may be acquired. Then, the storage processing unit 110 stores the acquired position information of the learning camera 22 into the suitable position information storage apparatus 120 as suitable position information (Step S115).

As described above, suitable position information is stored in the suitable position information storage apparatus 120 in a data format of at least one type out of data in an image format and numerical data indicating an angle.

As described above, learning data are constructed for each event. Therefore, for each event, the storage processing unit 110 may acquire suitable position information and store the information into the suitable position information storage apparatus 120.

Further, a display processing unit 108 may acquire selection information of an event and cause a suitable installation position corresponding to the selected event to be displayed. For example, the display processing unit 108 causes a display 32 of an operation terminal 30 to display a use interface (UI) accepting selection of at least one event from among a plurality of events. Examples of the UI include a radio button, a checkbox, a drop-down list, a combo box, and a drum roll but are not particularly limited. As described above, in a case of a takeout event of a product 7, selection of a predetermined condition such as a specific installation position of a display shelf 5 or a specific display position of a product 7 being a detection target may be further accepted, and the accepted condition may be included in the selection information of the event.

The display processing unit 108 acquires selection information by accepting selection of at least one event from among a plurality of events. For example, the display processing unit 108 may cause a suitable installation area 210 corresponding to an event selected by a radio button to be displayed, the area being changed every time selection is accepted.

Alternatively, the determination unit 106 may acquire selection information of an event, determine a suitable installation position corresponding to the selected event, and cause the display processing unit 108 to display the position.

As described above, at constructing learning data used for detecting an event by performing image processing on an image generated by the event detection camera 20, the storage processing unit 110 in the surveillance apparatus 100 according to the present example embodiment previously stores information allowing determination of the position of the learning camera 22 capturing an image of a surveillance target position into the suitable position information storage apparatus 120 as suitable position information. Then, the position information acquisition unit 102 acquires the suitable position information by readout from the suitable position information storage apparatus 120.

Thus, the surveillance apparatus 100 according to the present example embodiment provides effects similar to those of the aforementioned example embodiment and further sets, to a suitable installation position, the same position as the position of the learning camera 22 at constructing learning data for detecting an event being a surveillance target of the surveillance apparatus 100; and therefore an effect of the learning data can be maximized without degrading precision of event detection using the learning data. Therefore, even when a clerk without expertise in an AI technology moves the event detection camera 20, installation work of the event detection camera 20 can be performed without degrading precision of event detection. In other words, the present example embodiment can assist installation work of the movable event detection camera 20.

Further, suitable position information may be stored in an image format indicating an area where the event detection camera 20 may be installed or may be stored as numerical data indicating an installation direction of the event detection camera 20 based on a surveillance target position. With the configuration, information allowing determination of the position of the learning camera 22 at constructing learning data for event detection can be stored into the suitable position information storage apparatus 120 in a suitable format, based on the storage capacity of the storage apparatuses in the computer 1000 (the memory 1030 and the storage device 1040), the throughput of the processor 1020 in the computer 1000, the type of event, and the like.

Further, the event detection camera 20 can be installed at an installation position considered suitable for learning data for detecting an event, and therefore an image captured by the event detection camera 20 installed based on the suitable installation position can be used for event detection, and degradation in precision of event detection can be prevented. Further, even when a plurality of events are set to be detection targets, display of a suitable installation position for each event can be performed by the display processing unit 108, or acquisition of selection information of an event and selective display of a plurality of suitable installation positions, or display of a result of the logical conjunction of a plurality of suitable installation positions can be performed, and therefore a suitable installation position suited for an event to be detected can be provided to an installer such as a clerk.

### Third Example Embodiment

FIG. 13 is a functional block diagram illustrating a configuration example of a main part of a surveillance apparatus 100 according to an example embodiment. The present example embodiment is the same as the aforementioned example embodiment except for including a configuration in which recommendation information about the installation position of a positioning camera 10 is provided. The surveillance apparatus 100 in FIG. 13 further includes an output processing unit 112 in addition to the configuration according to the first example embodiment in FIG. 1. Note that the configuration according to the present example embodiment may be combined with at least one of configurations according to other example embodiments without contradicting each other.

### <Functional Configuration Example>

The output processing unit 112 causes an output unit to, based on an event, output recommendation information about the installation position of the positioning camera 10 capturing an image acquired by a position information acquisition unit 102.

The installation position of the positioning camera 10 is preferably installed at a position P being a basis of an event detection target, as illustrated in FIG. 6. Then, according to the present example embodiment, a surveillance target position at acquisition of learning data is further stored into a suitable position information storage apparatus 120 for each event. Then, recommendation information is caused to be output before the start of image capture by the positioning camera 10 in Step S101 in FIG. 2.

Recommendation information indicating an installation position of the positioning camera 10 may include at least one of a floor name, a location of a display shelf 5, a position in the display shelf 5 [a position in at least one of a horizontal direction and a vertical direction (the number of tiers)]. Alternatively, recommendation information may be a value indicated by position information based on the Global Positioning System (GPS).

Specifically, the output processing unit 112 acquires selection information of an event being a detection target, acquires a recommended installation position of the positioning camera 10 corresponding to the acquired event, and causes the output unit to output the position. Without being particularly limited, examples of the recommendation information may include a floor name, a location of a display shelf 5, a position in the display shelf 5 [a position in at least one of the horizontal direction and the vertical direction (the number of tiers)]. Alternatively, as will be described later, the recommendation information may include information prompting fine adjustment of an installation position in such a way that the installation position is adjusted to the recommended installation position by using the current position of the positioning camera 10, such as “a little more to the right” or “a little more to the front.” Alternatively, the recommendation information may include information indicating correct installation at the recommended installation position by using the current position of the positioning camera 10 (such as a notification sound or a voice message such as “correctly installed”).

Alternatively, the recommendation information may illustrate a recommended installation position on a screen. Furthermore, the recommendation information may be information displaying the current position of the positioning camera 10 by superimposition on the illustrated recommended installation position and prompting movement in such a way that the recommended installation position and the current position overlap each other. The current position of the positioning camera 10 can be determined by acquiring position information determined by a Global Positioning System (GPS) reception function of the positioning camera 10.

For example, the output unit may output a voice to a speaker (unillustrated) in at least one of an operation terminal 30 and the positioning camera 10 or output an image or character information to a display of at least one of the operation terminal 30 and the positioning camera 10.

### <Operation Example>

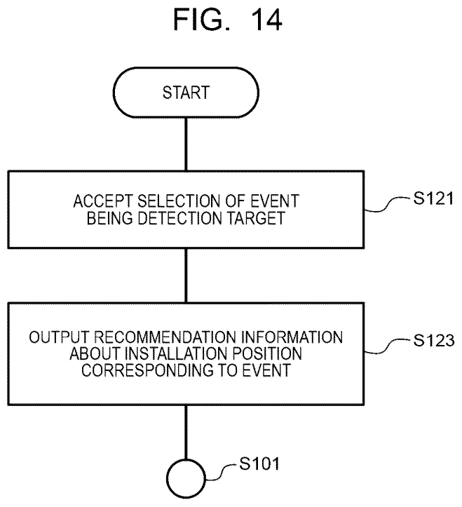

FIG. 14 is a flowchart illustrating an operation example of the surveillance apparatus 100 according to the example embodiment.

The flow is executed before Step S101 in FIG. 1. First, the output processing unit 112 acquires selection information of an event being a detection target (Step S121). As described above, the output processing unit 112 causes a UI accepting selection of an event to be displayed on a screen, accepts selection of an event, and acquires selection information.

Then, the output processing unit 112 acquires recommendation information indicating an installation position of the positioning camera 10 corresponding to the selected event by readout from the suitable position information storage apparatus 120 and causes the output unit to output the information (Step S123). For example, the output processing unit 112 causes a display 32 of the operation terminal 30 to display the recommendation information or causes a speaker in the operation terminal 30 to output the recommendation information by voice.

As described above, the output processing unit 112 in the surveillance apparatus 100 according to the present example embodiment causes the output unit to, based on an event, output recommendation information about the installation position of the positioning camera 10 capturing an image acquired by the position information acquisition unit 102.

Thus, the surveillance apparatus 100 according to the present example embodiment provides effects similar to those of the aforementioned example embodiments and further enables the installation position of the positioning camera 10 to be installed at a suitable position, and therefore an event detection camera 20 can be installed at a suitable position and a factor of degradation in precision of event detection caused by misalignment of the installation position of the positioning camera 10 can be eliminated. Further, the positioning camera 10 can be installed based on recommendation information, and therefore installation work at installation of the positioning camera 10 by a worker can be assisted.

### Fifth Example Embodiment

FIG. 15 is a functional block diagram illustrating a logical configuration example of a surveillance apparatus 100 according to an example embodiment. The present example embodiment is the same as one of the aforementioned example embodiments except for including a configuration in which installation of an event detection camera 20 is supported. FIG. 15 includes the same configuration as that in FIG. 1 and further includes a decision unit 114 and a notification unit 116. Note that the configuration according to the present example embodiment may be combined with at least one of configurations according to other example embodiments without contradicting each other.

### <Functional Configuration Example>

The decision unit 114 decides whether the event detection camera 20 is installed within an area indicated by a suitable installation position by processing an image acquired by a position information acquisition unit 102.

The notification unit 116 makes notification that the event detection camera 20 is installed within the area indicated by the suitable installation position, based on the decision result made by the decision unit 114.

Status in which the event detection camera 20 is installed in a state of a suitable installation area 210 being displayed on a screen 200 by a display processing unit 108 is assumed herein. Further, an image processing apparatus 150 is assumed to be previously trained in such a way as to be able to detect the event detection camera 20.

The decision unit 114 causes the image processing apparatus 150 to perform image processing on an image captured by a positioning camera 10 and determine a position of the event detection camera 20 in the image. Then, the decision unit 114 decides whether the determined position of the event detection camera 20 is included within an area indicating a suitable installation position determined by a determination unit 106, such as the suitable installation area 210 on the screen 200.

Furthermore, at acquisition of the installation position of a learning camera 22, information allowing determination of at least one of the angle of view and the direction of the lens relative to the surveillance target position of the learning camera 22 may be acquired from the learning camera 22 and be stored into a suitable position information storage apparatus 120. Then, the decision unit 114 may acquire information allowing determination of at least one of the angle of view and the direction of the lens of the event detection camera 20 from the event detection camera 20 and decide whether the information is the same as a setting of the learning camera 22 (or within a predetermined range).

When the decision result made by the decision unit 114 indicates that the position of the event detection camera 20 is decided to be included within an area indicating a suitable installation position, the notification unit 116 makes notification that the event detection camera 20 is installed within the area indicated by the suitable installation position. Specifically, the notification unit 116 outputs a notification sound or a notification message voice from a speaker in at least one of the positioning camera 10 and an operation terminal 30.

Alternatively, the notification unit 116 may cause information indicating that the event detection camera 20 is installed within the area indicated by the suitable installation position to be displayed on a display of at least one of the positioning camera 10 and the operation terminal 30. Specifically, at least one item out of the camera not being installed within the area indicated by the suitable installation position and the camera being installed within the area indicated by the suitable installation position may be notified on the screen 200 in FIG. 8 by changing display of the suitable installation area 210 to highlighting such as blinking. In other words, highlighting may be executed until the camera is installed within the area indicated by the suitable installation position and be stopped when the camera is installed within the area indicated by the suitable installation position. On the other hand, highlighting may be suspended until the camera is installed within the area indicated by the suitable installation position and be executed when the camera is installed within the area indicated by the suitable installation position.

### <Operation Example>

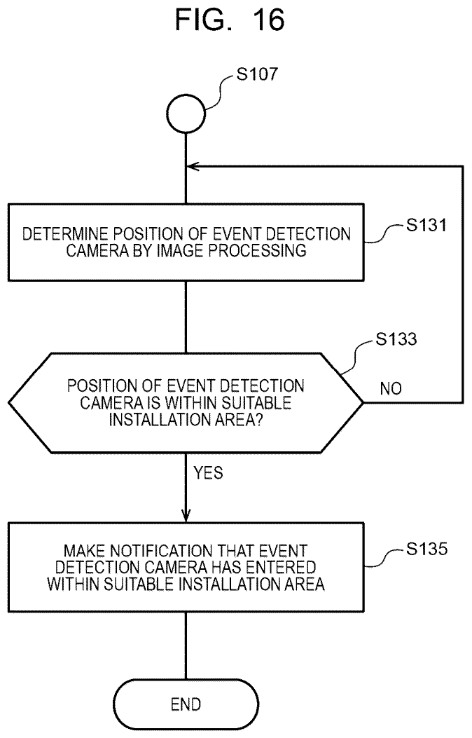

FIG. 16 is a flowchart illustrating an operation example of the surveillance apparatus 100 according to the example embodiment.

The flow is started after Step S107 in FIG. 2.

Then, the decision unit 114 first transmits an image captured by the positioning camera 10 to the image processing apparatus 150 and cause the image processing apparatus 150 to perform image processing and determine the position of the event detection camera 20 (Step S131). When acquiring the position of the event detection camera 20, the decision unit 114 decides whether the position of the event detection camera 20 is within an area indicating a suitable installation position determined in Step S105 in FIG. 2 (Step S133).

Then, when the event detection camera 20 is decided to be within the area indicating the suitable installation position (YES in Step S133), the notification unit 116 makes notification that the event detection camera 20 has entered the area of the suitable installation position (Step S135). On the other hand, while the event detection camera 20 is decided to be not within the area indicating the suitable installation position in Step S133 (NO in Step S133), the processing returns to Step S131, and processing of acquiring an image of the positioning camera 10 and causing the image processing apparatus 150 to determine the position of the event detection camera 20 is repeated. Further, while the processing may be ended after the notification in Step S135, for example, the processing may return to Step S131, and subsequently, whether the position of the event detection camera 20 is out of the area of the suitable installation position may be repeatedly decided, and notification of the result may be made.

For example, when the event detection camera 20 enters the area of the suitable installation position, the notification unit 116 causes the speaker in the event detection camera 20 to output a notification sound. Thus, a worker installing the event detection camera 20 can learn that the event detection camera 20 is installed at a suitable position.

Alternatively, the display processing unit 108 may cause the drawing element of the suitable installation area 210 to be highlighted on the screen 200 in FIG. 8 until the event detection camera 20 enters the suitable installation area 210 (NO in Step S133). Then, when the event detection camera 20 enters the suitable installation area 210 (YES in Step S133), the notification unit 116 may make notification that the event detection camera 20 has entered the area of the suitable installation position by causing the display processing unit 108 to suspend the highlighting (Step S135).

Alternatively, the display processing unit 108 may cause the drawing element of the suitable installation area 210 to be displayed normally on the screen 200 in FIG. 8 until the event detection camera 20 enters the suitable installation area 210 (NO in Step S133). Then, when the event detection camera 20 enters the suitable installation area 210 (YES in Step S133), the notification unit 116 may make notification that the event detection camera 20 has entered the area of the suitable installation position by causing the display processing unit 108 to highlight the drawing element of the suitable installation area 210 (Step S135).

As described above, in the surveillance apparatus 100 according to the present example embodiment, the decision unit 114 decides whether the event detection camera 20 is installed within an area indicated by a suitable installation position by processing an image acquired by the position information acquisition unit 102, and the notification unit 116 makes notification that the event detection camera 20 is installed within the area indicated by the suitable installation position, based on the decision result made by the decision unit 114.

Thus, the surveillance apparatus 100 according to the present example embodiment provides effects similar to those of the aforementioned example embodiments and further makes notification whether the event detection camera 20 is installed within an area indicated by a suitable installation position, and therefore installation work of the event detection camera 20 can be assisted. Further, the event detection camera 20 can be installed at a suitable position, and therefore a factor of degradation in precision of event detection caused by misalignment of the installation position of the event detection camera 20 can be eliminated.

### Sixth Example Embodiment

FIG. 17 is a diagram illustrating a configuration example of a surveillance apparatus 100 using an event detection camera 20 installed at a suitable position by the surveillance apparatus 100 according to the aforementioned example embodiment. According to the present example embodiment, the surveillance apparatus 100 in the surveillance system 1 illustrated in FIG. 3 includes a configuration in which an event is detected by using an image processing apparatus 150. The configuration of the surveillance apparatus 100 according to the present example embodiment represents the surveillance apparatus 100 in operation. Note that the configuration according to the present example embodiment may be combined with at least one of configurations according to other example embodiments without contradicting each other.

The surveillance apparatus 100 further includes an event detection unit 130.

The event detection unit 130 detects an event by performing, by using learning data, image processing on an image generated by the event detection camera 20.

The surveillance apparatus 100 further includes a camera-side communication unit 132 and an AI-side communication unit 134. The camera-side communication unit 132 has a communication function for connecting the event detection camera 20 to a communication network 3. The AI-side communication unit 134 has a communication function for connecting the surveillance apparatus 100 to the communication network 3.

An image captured by the event detection camera 20 is transmitted to the surveillance apparatus 100 through the camera-side communication unit 132. Then, the event detection unit 130 receives the image captured by the event detection camera 20 through the AI-side communication unit 134. Then, the event detection unit 130 causes the image processing apparatus 150 to perform image processing on the received image and detect an event.

As described above, the event detection unit 130 in the surveillance apparatus 100 according to the present example embodiment detects an event by performing, by using learning data, image processing on an image generated by the event detection camera 20.

Thus, the surveillance apparatus 100 according to the present example embodiment provides effects similar to those of the aforementioned example embodiments and further detects an event by performing, by using learning data for event detection, image processing on an image generated by the event detection camera 20 installed at a suitable installation position determined at generation of the learning data, and therefore recognition precision can be kept to the maximum. Furthermore, moving work of the event detection camera 20 in such a surveillance apparatus 100 can be assisted.

While the example embodiments of the present invention have been described above with reference to the drawings, the example embodiments are exemplifications of the present invention, and various configurations other than those described above may also be employed.

Further, while a plurality of processes (processing) are described in a sequential order in each of a plurality of flowcharts used in the aforementioned description, the execution order of processes executed in each example embodiment is not limited to the order of description. The order of the illustrated processes may be modified without affecting the contents in each example embodiment. Further, at least one process may be performed by another operating entity such as another apparatus or person. Further, the aforementioned example embodiments may be combined without contradicting each other.

While the present invention has been described above with reference to the example embodiments, the present invention is not limited to the aforementioned example embodiments. Various changes and modifications that may be understood by a person skilled in the art may be made to the configurations and details of the present invention, within the scope of the present invention.

Note that, when information about a user (including a customer or a passenger) is acquired and used in the present invention, the acquisition and the use are assumed to be performed legally.

The whole or part of the example embodiments disclosed above may also be described as, but not limited to, the following supplementary notes.

1. A surveillance apparatus including:
a position information acquisition unit that acquires suitable position information allowing determination of a suitable installation position of an image capture unit that surveilles a surveillance target position;
an image acquisition unit that acquires an image in which an area where the image capture unit may be installed is captured;
a determination unit that determines the suitable installation position in the image by using the suitable position information; and
a display processing unit that causes a display unit to display the determined suitable installation position by superimposition on the image.

2. The surveillance apparatus according to 1., wherein
the image is an image captured from the surveillance target position.

3. The surveillance apparatus according to 2., wherein
the suitable position information indicates an image capture direction of the image capture unit based on the surveillance target position.

4. The surveillance apparatus according to any one of 1. to 3., wherein
the surveillance target position includes at least part of a product shelf.

5. The surveillance apparatus according to any one of 1. to 4., further including
a storage processing unit that, at constructing learning data used for detecting an event by performing image processing on an image generated by the image capture unit, previously stores information allowing determination of a position of an image capture unit that captures an image of the surveillance target position into a storage unit as the suitable position information, wherein
the position information acquisition unit acquires the suitable position information by readout from the storage unit.

6. The surveillance apparatus according to 5., wherein
the storage processing unit stores the suitable position information into the storage unit in an image format indicating an area where the image capture unit may be installed.

7. The surveillance apparatus according to 5, or 6., wherein
the storage processing unit stores the suitable position information into the storage unit as numerical data indicating an installation direction of the image capture unit based on the surveillance target position.

8. The surveillance apparatus according to any one of 1. to 7., wherein
an image generated by the image capture unit is used for detecting an event, and
the position information acquisition unit acquires the suitable position information for the each event.

9. The surveillance apparatus according to 8., wherein,
when a plurality of the events are set to be detection targets, the determination unit determines the suitable installation position by using a plurality of pieces of the suitable position information of a plurality of the events.

10. The surveillance apparatus according to 8, or 9., wherein
the display processing unit acquires selection information of the event and causes the suitable installation position corresponding to the selected event to be displayed.

11. The surveillance apparatus according to any one of 8. to 10., further including
an output processing unit that causes an output unit to, based on the event, output recommendation information about an installation position of an image capture unit that captures the image acquired by the image acquisition unit.

12. The surveillance apparatus according to any one of 1. to 11., further including:
a decision unit that, by processing the image acquired by the image acquisition unit, decides whether the image capture unit is installed within an area indicated by the suitable installation position; and
a notification unit that, based on a decision result made by the decision unit, makes notification that the image capture unit is installed within the area indicated by the suitable installation position.

13. The surveillance apparatus according to any one of 1. to 12., further including
an event detection unit that detects an event by performing, by using learning data, image processing on an image generated by the image capture unit.

14. The surveillance apparatus according to any one of 1. to 13., wherein
the image capture unit is a movable wireless camera.

15. A surveillance system including:
a second image capture unit that captures, from a surveillance target position, an image of an area where a first image capture unit that surveilles the surveillance target position may be installed;
a storage unit that stores suitable position information allowing determination of a suitable installation position of the first image capture unit;
a display unit;
a position information acquisition unit that acquires the suitable position information from the storage unit;
an image acquisition unit that acquires an image of an area where the first image capture unit an image of which is captured by the second image capture unit may be installed;
a determination unit that determines the suitable installation position in the image by using the suitable position information; and
a display processing unit that causes the display unit to display the determined suitable installation position by superimposition on the image.

16. The surveillance system according to 15., wherein
the image is an image captured from the surveillance target position.

17. The surveillance system according to 16., wherein
the suitable position information indicates an image capture direction of the first image capture unit based on the surveillance target position.

18. The surveillance system according to any one of 15. to 17., wherein
the surveillance target position includes at least part of a product shelf.

19. The surveillance system according to any one of 15. to 18., further including
a storage processing unit that, at constructing learning data used for detecting an event by performing image processing on an image generated by the first image capture unit, previously stores information allowing determination of a position of a third image capture unit that captures an image of the surveillance target position into a storage unit as the suitable position information, wherein
the position information acquisition unit acquires the suitable position information by readout from the storage unit.

20. The surveillance system according to 19., wherein
the storage processing unit stores the suitable position information into the storage unit in an image format indicating an area where the first image capture unit may be installed.

21. The surveillance system according to 19. or 20., wherein
the storage processing unit stores the suitable position information into the storage unit as numerical data indicating an installation direction of the first image capture unit based on the surveillance target position.

22. The surveillance system according to any one of 15. to 21., wherein
an image generated by the first image capture unit is used for detecting an event, and
the position information acquisition unit acquires the suitable position information for the each event.

23. The surveillance system according to 22., wherein,
when a plurality of the events are set to be detection targets, the determination unit determines the suitable installation position by using a plurality of pieces of the suitable position information of a plurality of the events.

24. The surveillance system according to 22. or 23., wherein
the display processing unit acquires selection information of the event and causes the suitable installation position corresponding to the selected event to be displayed.

25. The surveillance system according to any one of 22. to 24., further including
an output processing unit that causes an output unit to, based on the event, output recommendation information about an installation position of the second image capture unit.

26. The surveillance system according to any one of 15. to 25., further including:
a decision unit that, by processing the image acquired by the image acquisition unit, decides whether the first image capture unit is installed within an area indicated by the suitable installation position; and
a notification unit that, based on a decision result made by the decision unit, makes notification that the first image capture unit is installed within the area indicated by the suitable installation position.

27. The surveillance system according to any one of 15. to 26., further including
an event detection unit that detects an event by performing, by using learning data, image processing on an image generated by the first image capture unit.

28. The surveillance system according to any one of 15. to 27., wherein
the first image capture unit is a movable wireless camera.

29. A surveillance method including, by one or more computers:
acquiring suitable position information allowing determination of a suitable installation position of an image capture unit that surveilles a surveillance target position;
acquiring an image in which an area where the image capture unit may be installed is captured;
determining the suitable installation position in the image by using the suitable position information; and
causing a display unit to display the determined suitable installation position by superimposition on the image.

30. The surveillance method according to 29., wherein
the image is an image captured from the surveillance target position.

31. The surveillance method according to 30., wherein
the suitable position information indicates an image capture direction of the image capture unit based on the surveillance target position.

32. The surveillance method according to any one of 29. to 31., wherein
the surveillance target position includes at least part of a product shelf.

33. The surveillance method according to any one of 29. to 32., further comprising, by the one or more computers:
at constructing learning data used for detecting an event by performing image processing on an image generated by the image capture unit, previously storing information allowing determination of a position of an image capture unit that captures an image of the surveillance target position into a storage unit as the suitable position information; and
acquiring the suitable position information by readout from the storage unit.

34. The surveillance method according to 33., further including, by the one or more computers,
storing the suitable position information into the storage unit in an image format indicating an area where the image capture unit may be installed.

35. The surveillance method according to 33. or 34., further including, by the one or more computers,
storing the suitable position information into the storage unit as numerical data indicating an installation direction of the image capture unit based on the surveillance target position.

36. The surveillance method according to any one of 29. to 35., wherein
an image generated by the image capture unit is used for detecting an event, and
the surveillance method further includes, by the one or more computers,
acquiring the suitable position information for the each event.

37. The surveillance method according to 36., further including, by the one or more computers,
when a plurality of the events are set to be detection targets, determining the suitable installation position by using a plurality of pieces of the suitable position information of a plurality of the events.

38. The surveillance method according to 36. or 37., further including, by the one or more computers,
acquiring selection information of the event and causing the suitable installation position corresponding to the selected event to be displayed.

39. The surveillance method according to any one of 36. to 38., further including, by the one or more computers,
causing an output unit to, based on the event, output recommendation information about an installation position of an image capture unit that captures an image of the acquired image.

40. The surveillance method according to any one of 29. to 39., further including, by the one or more computers:
by processing the acquired image, deciding whether the image capture unit is installed within an area indicated by the suitable installation position; and,
based on a decision result, making notification that the image capture unit is installed within the area indicated by the suitable installation position.

41. The surveillance method according to any one of 29. to 40., further including, by the one or more computers,
detecting an event by performing, by using learning data, image processing on an image generated by the image capture unit.

42. The surveillance method according to any one of 29. to 41., wherein the image capture unit is a movable wireless camera.

43. A computer-readable recording medium on which a program is recorded, the program causing a computer to execute:
a procedure for acquiring suitable position information allowing determination of a suitable installation position of a first image capture unit that surveilles a surveillance target position;
a procedure for acquiring an image in which an area where the first image capture unit may be installed is captured;
a procedure for determining the suitable installation position in the image by using the suitable position information; and
a procedure for causing a display unit to display the determined suitable installation position by superimposition on the image.

44. The recording medium according to 43., wherein
the image is an image captured from the surveillance target position.

45. The recording medium according to 44., wherein
the suitable position information indicates an image capture direction of the first image capture unit based on the surveillance target position.

46. The recording medium according to any one of 43. to 45., wherein
the surveillance target position includes at least part of a product shelf.

47. The recording medium according to any one of 43. to 46., wherein
the program further causes the computer to execute:
   a procedure for, at constructing learning data used for detecting an event by performing image processing on an image generated by the first image capture unit, previously storing information allowing determination of a position of a second image capture unit that captures an image of the surveillance target position into a storage unit as the suitable position information; and
   a procedure for acquiring the suitable position information by readout from the storage unit.

48. The recording medium according to 47., wherein
the program further causes the computer to execute a procedure for storing the suitable position information into the storage unit in an image format indicating an area where the first image capture unit may be installed.

49. The recording medium according to 47. or 48., wherein
the program further causes the computer to execute a procedure for storing the suitable position information into the storage unit as numerical data indicating an installation direction of the first image capture unit based on the surveillance target position.

50. The recording medium according to any one of 43. to 49., wherein
an image generated by the first image capture unit is used for detecting an event, and
the program further causes the computer to execute a procedure for acquiring the suitable position information for the each event.

51. The recording medium according to 50., wherein
the program further causes the computer to execute a procedure for, when a plurality of the events are set to be detection targets, determining the suitable installation position by using a plurality of pieces of the suitable position information of a plurality of the events.

52. The recording medium according to 50. or 51., wherein
the program further causes the computer to execute a procedure for acquiring selection information of the event and causing the suitable installation position corresponding to the selected event to be displayed.

53. The recording medium according to any one of 50. to 52., wherein
the program further causes the computer to execute a procedure for causing an output unit to, based on the event, output recommendation information about an installation position of a third image capture unit that captures an image of an area where the first image capture unit may be installed.

54. The recording medium according to any one of 43. to 53., wherein
the program further causes the computer to execute:
   a procedure for, by processing the acquired image, deciding whether the first image capture unit is installed within an area indicated by the suitable installation position; and
   a procedure for, based on a decision result made in the deciding procedure, making notification that the first image capture unit is installed within the area indicated by the suitable installation position.

55. The recording medium according to any one of 43. to 54., wherein
the program further causes the computer to execute a procedure for detecting an event by performing, by using learning data, image processing on an image generated by the first image capture unit.

56. The recording medium according to any one of 43. to 55., wherein
the first image capture unit is a movable wireless camera.

57. A program causing a computer to execute:
a procedure for acquiring suitable position information allowing determination of a suitable installation position of a first image capture unit that surveilles a surveillance target position;
a procedure for acquiring an image in which an area where the first image capture unit may be installed is captured;
a procedure for determining the suitable installation position in the image by using the suitable position information; and
a procedure for causing a display unit to display the determined suitable installation position by superimposition on the image.

58. The program according to 57., wherein
the image is an image captured from the surveillance target position.

59. The program according to 58., wherein
the suitable position information indicates an image capture direction of the first image capture unit based on the surveillance target position.

60. The program according to any one of 57. to 59., wherein
the surveillance target position includes at least part of a product shelf.

61. The program according to any one of 57. to 60., further causing the computer to execute:
a procedure for, at constructing learning data used for detecting an event by performing image processing on an image generated by the first image capture unit, previously storing information allowing determination of a position of a second image capture unit that captures an image of the surveillance target position into a storage unit as the suitable position information; and
a procedure for acquiring the suitable position information by readout from the storage unit.

62. The program according to 61., further causing the computer to execute
a procedure for storing the suitable position information into the storage unit in an image format indicating an area where the first image capture unit may be installed.

63. The program according to 61. or 62., further causing the computer to execute
a procedure for storing the suitable position information into the storage unit as numerical data indicating an installation direction of the first image capture unit based on the surveillance target position.

64. The program according to any one of 57. to 63., wherein
an image generated by the first image capture unit is used for detecting an event, and
the program further causes the computer to execute a procedure for acquiring the suitable position information for the each event.

65. The program according to 64., further causing the computer to execute
a procedure for, when a plurality of the events are set to be detection targets, determining the suitable installation position by using a plurality of pieces of the suitable position information of a plurality of the events.

66. The program according to 64. or 65., further causing the computer to execute
a procedure for acquiring selection information of the event and causing the suitable installation position corresponding to the selected event to be displayed.

67. The program according to any one of 64. to 66., further causing the computer to execute
a procedure for causing an output unit to, based on the event, output recommendation information about an installation position of a third image capture unit that captures an image of an area where the first image capture unit may be installed.

68. The program according to any one of 57. to 67., further causing the computer to execute:
a procedure for, by processing the acquired image, deciding whether the first image capture unit is installed within an area indicated by the suitable installation position; and
a procedure for, based on a decision result made in the deciding procedure, making notification that the first image capture unit is installed within the area indicated by the suitable installation position.

69. The program according to any one of 57. to 68., further causing the computer to execute
a procedure for detecting an event by performing, by using learning data, image processing on an image generated by the first image capture unit.

70. The program according to any one of 57. to 69., wherein
the first image capture unit is a movable wireless camera.

### REFERENCE SIGNS LIST

1 Surveillance system
3 Communication network
5 Display shelf
7 Product
10 Positioning camera
20 Event detection camera
22 Learning camera
30 Operation terminal
32 Display
34 Camera
50 Image plane
100 Surveillance apparatus
102 Position information acquisition unit
104 Image acquisition unit
106 Determination unit
108 Display processing unit
110 Storage processing unit
112 Output processing unit
114 Decision unit
116 Notification unit
120 Suitable position information storage apparatus
130 Event detection unit
132 Camera-side communication unit
134 AI-side communication unit
150 Image processing apparatus
160 Recognition model
200 Screen
210, 210a, 210b, 210c, 210d Suitable installation area
1000 Computer
1010 Bus
1020 Processor
1030 Memory
1040 Storage device
1050 Input/output interface
1060 Network interface

What is claimed is:

1. A surveillance apparatus comprising:
at least one memory storing instructions; and
at least one processor configured to execute the instructions to:
acquire suitable position information allowing determination of a suitable installation position of an image capture unit that surveilles a surveillance target position;
acquire an image in which an area where the image capture unit may be installed is captured;
determine the suitable installation position in the image by using the suitable position information; and
cause a display unit to display the determined suitable installation position by superimposition on the image.

2. The surveillance apparatus according to claim 1, wherein
the image is an image captured from the surveillance target position.

3. The surveillance apparatus according to claim 2, wherein
the suitable position information indicates an image capture direction of the image capture unit based on the surveillance target position.

4. The surveillance apparatus according to claim 1, wherein
the surveillance target position includes at least part of a product shelf.

5. The surveillance apparatus according to claim 1, wherein the at least one processor is further configured to execute the instructions to:
at constructing learning data used for detecting an event by performing image processing on an image generated by the image capture unit, previously store information allowing determination of a position of an image capture unit that captures an image of the surveillance target position into a storage unit as the suitable position information; and
acquire the suitable position information by readout from the storage unit.

6. The surveillance apparatus according to claim 5, wherein
the at least one processor is further configured to execute the instructions to
store the suitable position information into the storage unit in an image format indicating an area where the image capture unit may be installed.

7. The surveillance apparatus according to claim 5, wherein
the at least one processor is further configured to execute the instructions to
store the suitable position information into the storage unit as numerical data indicating an installation direction of the image capture unit based on the surveillance target position.

8. The surveillance apparatus according to claim 1, wherein
an image generated by the image capture unit is used for detecting an event, and
wherein the at least one processor is further configured to execute the instructions to
acquire the suitable position information for the each event.

9. The surveillance apparatus according to claim 8, wherein,
the at least one processor is further configured to execute the instructions to
when a plurality of the events are set to be detection targets, determine the suitable installation position by using a plurality of pieces of the suitable position information of a plurality of the events.

10. The surveillance apparatus according to claim 8, wherein
the at least one processor is further configured to execute the instructions to
acquire selection information of the event and causes the suitable installation position corresponding to the selected event to be displayed.

11. The surveillance apparatus according to claim 8, wherein the at least one processor is further configured to execute the instructions to
cause an output unit to, based on the event, output recommendation information about an installation position of an image capture unit that captures the image acquired.

12. The surveillance apparatus according to claim 1, wherein the at least one processor is further configured to execute the instructions to:
by processing the image acquired, decide whether the image capture unit is installed within an area indicated by the suitable installation position to obtain a decision result; and
based on the decision result, make notification that the image capture unit is installed within the area indicated by the suitable installation position.

13. The surveillance apparatus according to claim 1, wherein the at least one processor is further configured to execute the instructions to
detect an event by performing, by using learning data, image processing on an image generated by the image capture unit.

14. The surveillance apparatus according to claim 1, wherein
the image capture unit is a movable wireless camera.

15. A surveillance system comprising:
a second image capture unit that captures, from a surveillance target position, an image of an area where a first image capture unit that surveilles the surveillance target position may be installed;
a storage unit that stores suitable position information allowing determination of a suitable installation position of the first image capture unit;
a display unit; and
a surveillance apparatus according to claim 1.

16. The surveillance system according to claim 15, wherein the at least one processor of the surveillance apparatus is further configured to execute the instructions to:
at constructing learning data used for detecting an event by performing image processing on an image generated by the first image capture unit, previously store information allowing determination of a position of a third image capture unit that captures an image of the surveillance target position into the storage unit as the suitable position information; and
acquire the suitable position information by readout from the storage unit.

17. The surveillance system according to claim 15, wherein the at least one processor of the surveillance apparatus is further configured to execute the instructions to
detect an event by performing, by using learning data, image processing on an image generated by the first image capture unit.

18. A surveillance method comprising, by one or more computers:
acquiring suitable position information allowing determination of a suitable installation position of an image capture unit that surveilles a surveillance target position;
acquiring an image in which an area where the image capture unit may be installed is captured;
determining the suitable installation position in the image by using the suitable position information; and
causing a display unit to display the determined suitable installation position by superimposition on the image.

19. A non-transitory computer-readable a storage medium storing a program, the program causing a computer to execute:
a procedure for acquiring suitable position information allowing determination of a suitable installation position of an image capture unit that surveilles a surveillance target position;
a procedure for acquiring an image in which an area where the image capture unit may be installed is captured;
a procedure for determining the suitable installation position in the image by using the suitable position information; and
a procedure for causing a display unit to display the determined suitable installation position by superimposition on the image.
